(19) United States
(12) Patent Application Publication
(10) Pub. No.: US 2014/0333991 A1
(43) Pub. Date: Nov. 13, 2014

(54) DISPLAY PANEL AND DISPLAY DEVICE

(71) Applicant: Sharp Kabushiki Kaisha, Osaka-shi, Osaka (JP)

(72) Inventors: Eiji Satoh, Osaka-shi (JP); Kohzoh Nakamura, Osaka-shi (JP); Hisashi Watanabe, Osaka-shi (JP); Takahiro Nakahara, Osaka-shi (JP)

(21) Appl. No.: 14/372,050

(22) PCT Filed: Jan. 18, 2013
(86) PCT No.: PCT/JP2013/050996

§ 371 Date: Jul. 15, 2014

(30) Foreign Application Priority Data
Jan. 19, 2012 (JP) 2012-009445

(51) Int. Cl. G02F 1/167; G02F 1/133

(52) U.S. Cl. CPC G02F 1/167; G02F 1/13306
USPC 359/296

(57) ABSTRACT

A display panel includes: substrates (10) and (20) which are provided so as to face each other; and an optical modulation layer (30) which is provided between the substrates (10) and (20), which contains a plurality of shape anisotropic members (32), and which controls a transmittance of light having entered the display panel, the display panel changing an area of projection of the plurality of shape anisotropic members (32) to the substrates (10) and (20) by changing a frequency of a voltage to be applied to the optical modulation layer (30), and the display panel switching, between a direct current voltage having a frequency of 0 Hz and an alternating current voltage, the voltage to be applied to the optical modulation layer (30).

### TECHNICAL FIELD

The present invention relates to a display panel and a display device.

### BACKGROUND ART

A conventional liquid crystal display panel mainly includes a pair of glass substrates, a liquid crystal layer provided between the glass substrates, electrodes provided for the respective glass substrates, and polarizing plates attached to the respective glass substrates. According to such a liquid crystal display panel, light emitted from a backlight passes through the polarizing plates and the liquid crystal layer, and an image is recognized by a contrast appearing on a screen. However, before reaching a display screen, much of the light from the backlight is lost by being absorbed and reflected. This causes a decrease in light use efficiency. In particular, an optical loss occurring in the polarizing plates greatly affects a decrease in light use efficiency.

Note here that Patent Literature 1 discloses a transflective display which transmits or reflects light having entered a suspension layer containing a plurality of particles (see (a) and (b) of FIG. 19). According to the transflective display, small-plate-like metallic particles, for example are vertically or horizontally oriented by applying thereto a voltage, and a display is carried out by transmitting light from a backlight or reflecting external light. The configuration, in which a polarizing plate is omissible, allows a further increase in light use efficiency than a liquid crystal display panel.

Note also that Patent Literatures 2 and 3 each disclose an optical device which includes polymer flakes suspended in a fluid host and selectively switches their optical characteristics by a change in electric field to be applied.

### CITATION LIST

### Patent Literatures

### Patent Literature 1

Japanese Translation of PCT International Application, Tokuhyo, No. 2007-506152 A (Publication Date: Mar. 15, 2007)

### Patent Literature 2

Specification of U.S. Pat. No. 6,665,042 (Registration Date: Dec. 16, 2003)

### Patent Literature 3

Specification of U.S. Pat. No. 6,829,075 (Registration Date: Dec. 7, 2004)

### SUMMARY OF INVENTION

### Technical Problem

However, the transflective display of Patent Literature 1 has a problem such that a circuit configuration and an electrode preparation process are complicated. This is because the transflective display includes: a first circuit which generates an electric field for orienting metallic particles in a direction perpendicular to a substrate; and a second circuit which generates an electric field for orienting metallic particles in a direction parallel to a substrate (see (a) and (b) of FIG. 19). Specifically, the first circuit is configured to apply a voltage V1 to electrodes 5 and 6 having a first switch 11 (see (a) of FIG. 19), and the second circuit is configured to apply a voltage V2 to electrodes 8 and 9 having a second switch 12 (see (b) of FIG. 19).

Meanwhile, according to the optical device of each of Patent Literatures 2 and 3, a state of the flakes can be changed by an electric field in either one of directions from a state in which the flakes are parallel to a substrate to a state in which the flakes are perpendicular to the substrate, or from the state in which the flakes are perpendicular to the substrate to the state in which the flakes are parallel to the substrate. However, according to the optical device, the state of the flakes is changed in the other of the directions by thermal dispersion and gravity. Therefore, a sufficient rewriting speed (switching speed) cannot be obtained. This causes a problem such that the optical device cannot be used as a display device.

The present invention has been made in view of the problem, and an object of the present invention is to provide a display panel and a display device each of which is capable of increasing light use efficiency by a simple configuration.

### Solution to Problem

In order to attain the object, a display panel of the present invention includes: a first substrate and a second substrate which are provided so as to face each other, the first substrate being provided on a back surface side of the display panel, and the second substrate being provided on a display surface side of the display panel; and an optical modulation layer which is provided between the first substrate and the second substrate, which contains a plurality of shape anisotropic members, and which controls a transmittance of light having entered the display panel, the display panel changing an area of projection of the plurality of shape anisotropic members to the first substrate and the second substrate by changing a frequency of a voltage to be applied to the optical modulation layer, and the display panel switching, between a direct current voltage having a frequency of 0 Hz and an alternating current voltage, the voltage to be applied to the optical modulation layer.

### Advantageous Effects of Invention

According to the configuration of the present invention, light use efficiency can be increased by a simple configuration.

### BRIEF DESCRIPTION OF DRAWINGS

(a) through (c) of FIG. 1 are cross-sectional views each illustrating an overall configuration of a display device in accordance with Embodiment 1.

(a) of FIG. 2 illustrates a state in which light travels in (a) of FIG. 1, and (b) of FIG. 2 illustrates a state in which light travels in (b) of FIG. 1.

(a) of FIG. 3 is an image obtained by photographing how flakes are horizontally oriented (in plan view), and (b) of FIG. 3 is an image obtained by photographing how flakes are vertically oriented (in plan view).

(a) and (b) of FIG. 4 are cross-sectional views each showing a modification of the display device illustrated in FIG. 1.

(a) and (b) of FIG. 5 are cross-sectional views each illustrating an overall configuration of a display device in accordance with Embodiment 2.

(a) of FIG. 6 illustrates a state in which light travels in (a) of FIG. 5, and (b) of FIG. 6 illustrates a state in which light travels in (b) of FIG. 5.

(a) of FIG. 7 illustrates a state in which light travels in (a) of FIG. 5 in a case where a polarity of a direct current voltage is reversed, and (b) of FIG. 7 illustrates a state in which light travels in (b) of FIG. 5.

(a) and (b) of FIG. 8 each illustrate a state in which light travels in a case where the display device in accordance with Embodiment 2 is configured to be a see-through display device.

(a) and (b) of FIG. 9 are cross-sectional views each illustrating an overall configuration of a display device in accordance with Embodiment 3.

(a) and (b) of FIG. 10 are cross-sectional views each illustrating an overall configuration of a display device in accordance with Embodiment 4.

(a) and (b) of FIG. 11 are cross-sectional views each illustrating an overall configuration of the display device in accordance with Embodiment 2 which display device has a smaller cell thickness.

(a) and (b) of FIG. 12 are cross-sectional views each illustrating an overall configuration of the display device in accordance with Embodiment 1 in which display device flake ends are fixed to a substrate.

(a) and (b) of FIG. 13 each illustrate a method for producing a display panel in which a part of flakes are fixed to a substrate.

(a) through (c) of FIG. 14 are cross-sectional views each illustrating an overall configuration of the display device in accordance with Embodiment 2 in which display device bowl-shaped flakes are used.

(a) and (b) of FIG. 15 are cross-sectional views each illustrating an overall configuration of the display device in accordance with Embodiment 2 in which display device fiber-like flakes are used.

FIG. 16 is a perspective view illustrating an overall configuration of a shape anisotropic member obtained by coating transparent cylindrical glass with a reflective film.

(a) of FIG. 17 is an image obtained by photographing how glass fibers are horizontally oriented (in plan view), and (b) of FIG. 17 is an image obtained by photographing how glass fibers are vertically oriented (in plan view).

(a) of FIG. 18 shows a light reflection property of a conventional color filter, and (b) of FIG. 18 shows a light reflection property of a color filter of the present invention.

(a) and (b) of FIG. 19 are cross-sectional views each illustrating an overall configuration of a conventional transflective display.

### DESCRIPTION OF EMBODIMENTS

### Embodiment 1

A display device in accordance with Embodiment 1 of the present invention is described below with reference to the drawings.

(a) and (b) of FIG. 1 are cross-sectional views each illustrating an overall configuration of a display device 1 in accordance with Embodiment 1. The display device 1 includes a display panel 2, a backlight 3 which emits light to the display panel 2, and a driving circuit (not illustrated). The display device 1 is a transmissive display device which carries out a display by transmitting, through the display panel 2, light emitted from the backlight 3.

Note that the backlight 3 is identical in configuration to a conventional backlight. Accordingly, a description of a configuration of the backlight 3 is omitted here. For example, a surface light source device such as an edge backlight or a direct backlight can be appropriately used as the backlight 3. Further, a fluorescent tube, an LED, or the like can be appropriately used as a light source of the backlight 3.

The display panel 2 includes a pair of substrates 10 and 20 which are provided so as to face each other, and an optical modulation layer 30 which is provided between the pair of substrates 10 and 20. The substrate 10 (a first substrate) is provided on a backlight 3 side (back surface side) of the display panel 2, and the substrate 20 (a second substrate) is provided on a display surface side (observer side) of the display panel 2. Further, the display panel 2 includes many pixels which are provided in a matrix pattern.

The substrates 10 and 20 are provided with respective insulating substrates made of, for example, transparent glass substrates, and an electrode 12 (a first electrode) and an electrode 22 (a second electrode), respectively.

The substrate 10 constitutes an active matrix substrate. Specifically, the substrate 10 includes various signal lines (such as a scanning signal line and a data signal line), a thin film transistor (“TFT”), and an insulating film each of which is provided on a glass substrate 11, and the electrode 12 (a pixel electrode) which is provided on the various signal lines, the thin film transistor, and the insulating film. Driving circuits (such as a scanning signal line driving circuit and a data signal line driving circuit) for driving the various signal lines are each identical in configuration to a conventional driving circuit.

The substrate 20 includes the electrode 22 (a common electrode) which is provided on a glass substrate 21.

The electrode 12 which is provided in the substrate 10 and the electrode 22 which is provided in the substrate 20 are made of transparent electrically conductive films containing, for example, ITO (Indium Tin Oxide), IZO (Indium Zinc Oxide), zinc oxide, or tin oxide. Further, the electrode 12 is provided for each of the pixels, and the electrode 22 is provided all over the pixels so as to be shared by all the pixels. Note that the electrode 22 may be provided for each of the pixels as in the case of the electrode 12.

The optical modulation layer 30 is provided between the electrodes 12 and 22, and includes a medium 31 and a plurality of shape anisotropic members 32 which are contained in the medium 31. The optical modulation layer 30 receives a voltage applied from a voltage source 33 which is connected with each of the electrodes 12 and 22. In accordance with a change in frequency of the applied voltage, the optical modulation layer 30 changes a transmittance of light having entered the optical modulation layer 30 from the backlight 3. Note here that a voltage with a frequency of 0 Hz in an alternating current is herein referred to as a “direct current voltage”. A thickness (cell thickness) of the optical modulation layer 30 is set in accordance with a length of a long axis of each of the plurality of shape anisotropic members 32. The thickness is set to, for example, 80 μm.

A shape anisotropic member 32 is a responsive member which rotates or deforms in accordance with a direction in which an electric field extends. In terms of a display characteristic, the shape anisotropic member 32 is a member such that an area of a projection image of the shape anisotropic member 32 seen from a direction normal to the substrates 10 and 20 (an area of projection of the shape anisotropic member 32 on the substrates 10 and 20) changes in accordance with a change in frequency of an applied voltage. Further, a projected area ratio (a ratio between a maximum projected area and a minimum projected area) is preferably not less than 2:1.

The shape anisotropic member 32 is a member which has a positive or negative electrostatic property in the medium 31. Specifically, for example, a member which can exchange electrons with, for example, an electrode and a medium, or a member which is modified by an ionic silane coupling agent or the like can be used as the shape anisotropic member 32.

The shape anisotropic member 32 can have a shape such as a flaky shape, a cylindrical shape, or an elliptic spherical shape. The shape anisotropic member 32 can be made of metal, a semiconductor, a dielectric substance, or a composite material of these materials. Alternatively, the shape anisotropic member 32 can also be made of a dielectric multilayer film or cholesteric resin. Further, an aluminum flake for use in general coating can be used for the shape anisotropic member 32 which is made of metal. The shape anisotropic member 32 may be colored. For example, an aluminum flake having a diameter of 20 μm and a thickness of 0.3 μm can be used as the shape anisotropic member 32.

The shape anisotropic member 32 preferably has a specific gravity of not more than 11 g/cm³, more preferably has a specific gravity of not more than 3 g/cm³, and still more preferably has a specific gravity equal to that of the medium 31. This is because the shape anisotropic member 32 which has a larger specific gravity than the medium 31 causes a problem of sedimentation or floating of the shape anisotropic member 32.

The medium 31 is a material which has transmissivity in a visible light region. It is possible to use, as the medium 31, a liquid which is substantially unabsorbent in the visible light region, a liquid which is obtained by coloring such a liquid with a coloring matter, or the like. Note that the medium 31 preferably has a specific gravity which is equal to that of the shape anisotropic member 32.

In view of a step of sealing the medium 31 in a cell, the medium 31 is preferably a less volatile medium. A viscosity of the medium 31 is involved in responsiveness. The medium 31 preferably has a viscosity of not more than 5 mPa·s. In order to prevent sedimentation of the shape anisotropic member 31, the medium 31 more preferably has a viscosity of not less than 0.5 mPa·s.

The medium 31 may be made of a single substance or a mixture of a plurality of substances. For example, propylene carbonate, NMP (N-methyl-2-pyrrolidone), fluorocarbon, silicone oil, and the like can be used for the medium 31.

The following description specifically discusses a method in which the optical modulation layer 30 controls a transmittance of light. A case where a flake is used as the shape anisotropic member 32 is described here.

In a case where a voltage (alternating current voltage) having a frequency of, for example, 60 Hz is applied as a high frequency voltage to the optical modulation layer 30, flakes rotate, by a force explained from a dielectrophoresis phenomenon, the Coulomb force, or a viewpoint of electric energy, so that their long axes are parallel to electric lines of force (see (b) of FIG. 2). That is, the flakes are oriented (hereinafter also referred to as vertically oriented) so that their long axes are vertical to the substrates 10 and 20. This causes light having entered the optical modulation layer 30 from the backlight 3 to be transmitted (pass) through the optical modulation layer 30 and then exit to the observer side.

Meanwhile, in a case where a voltage having a frequency of, for example, 0.1 Hz or a direct current voltage (having a frequency of 0 Hz) is applied as a low frequency voltage to the optical modulation layer 30, flakes having an electrostatic property are drawn, by a force explained from an electrophoresis force or the Coulomb force, to a vicinity of the electrode which is charged with an electric charge whose polarity is reverse to that of an electric charge with which the flakes are charged. Then, while being most stably oriented, the flakes rotate so as to adhere to the substrate 10 or the substrate 20. For example, (a) of FIG. 2 illustrates a state in which a polarity (positive) of an electric charge with which the electrode 22 of the substrate 20 is charged and a polarity (negative) of an electric charge with which the flakes are charged differ from each other and the flakes are oriented so as to adhere to the substrate 20. That is, the flakes are oriented (hereinafter also referred to as horizontally oriented) so that their long axes are parallel to the substrates 10 and 20. This causes light having entered the optical modulation layer 30 from the backlight 3 to be blocked by the flakes, so that the light is not transmitted (does not pass) through the optical modulation layer 30.

As described earlier, in a case where a voltage to be applied to the optical modulation layer 30 is switched between a direct current voltage having a frequency of 0 Hz and an alternating current voltage or between a low frequency voltage and a high frequency voltage, a transmittance (transmitted light amount) of light having entered the optical modulation layer 30 from the backlight 3 can be changed. Note that the flakes are horizontally oriented (orientation of the flakes is switched to horizontal orientation) at a frequency of, for example, 0 Hz to 0.5 Hz and that the flakes are vertically oriented (orientation of the flakes is switched to vertical orientation) at a frequency of, for example, 30 Hz to 1 kHz. These frequencies are set in advance in accordance with, for example the thickness (cell thickness) of the optical modulation layer 30. That is, the display device 1 is configured such that a transmittance (transmitted light amount) of light is changed by switching a frequency of a voltage to be applied to the optical modulation layer 30 between a low frequency of not more than a first threshold value and a high frequency of not less than a second threshold value. For example, the first threshold value and the second threshold value can be set here to 0.5 Hz and 30 Hz, respectively.

Note here that a flake which is used as the shape anisotropic member 32 has a thickness preferably of not more than 1 μm, and more preferably of not more than 0.1 μm. A smaller thickness of the flake allows a further increase in transmittance.

(a) of FIG. 3 is an image obtained by photographing how the flakes are horizontally oriented (in plan view), and (b) of FIG. 3 is an image obtained by photographing how the flakes are vertically oriented (in plan view). Here, photographing is carried out by using propylene carbonate for the medium 31, using, as the shape anisotropic members 32, aluminum flakes having a diameter of 20 μm and a thickness of 0.3 μm, setting the cell thickness to 79 μm, setting an applied voltage to 5.0 V (alternating current), and switching a frequency of the applied voltage between 0 Hz (direct current) and 60 Hz. It is revealed that the flakes are horizontally oriented in a case where the frequency is set to 0 Hz (direct current) (see (a) of FIG. 3) and that the flakes are vertically oriented in a case where the frequency is set to 60 Hz (high frequency) (see (b) of FIG. 3).

Note that in (a) of FIG. 1, the voltage source 33 has a negative terminal which is connected with the electrode 12 and a positive terminal which is connected with the electrode 22. However, the present invention is not limited to such a configuration. As illustrated in (c) of FIG. 1, the voltage source 33 may have a negative terminal which is connected with the electrode 22 and a positive terminal which is connected with the electrode 12. According to the configuration of (c) of FIG. 1, the flakes are oriented so as to adhere to the substrate 10. Note also that FIG. 1 illustrates a case where the flakes are charged with an electric charge whose polarity is negative. However, the present invention is not limited to such a configuration. The flakes may be charged with an electric charge whose polarity is positive. In this case, as shown in (a) and (b) of FIG. 4, the flakes adhere to the substrate which is opposite to the substrate of each of (a) and (c) of FIG. 1.

### Embodiment 2

A display device in accordance with Embodiment 2 of the present invention is described below with reference to the drawings.

Note that the following description mainly discusses points of difference from the display device in accordance with Embodiment 1. Note also that members having functions identical to those of the respective members described in Embodiment 1 are given respective identical reference numerals, and a description of those members is omitted here.

(a) and (b) of FIG. 5 are cross-sectional views each illustrating an overall configuration of a display device 1a in accordance with Embodiment 2. The display device 1a includes a display panel 2a and a driving circuit (not illustrated). The display device 1a is a reflective display device which carries out a display by reflecting external light having entered the display panel 2a.

The display panel 2a includes a pair of substrates 10a and 20 which are provided so as to face each other, and an optical modulation layer 30a which is provided between the pair of substrates 10a and 20. The substrate 10a (a first substrate) is provided on a back surface side of the display panel 2a, and the substrate 20 (a second substrate) is provided on a display surface side (observer side) of the display panel 2a. Further, the display panel 2a includes many pixels which are provided in a matrix pattern.

The substrates 10a and 20 are provided with respective insulating substrates made of, for example, transparent glass substrates, and an electrode 12 (a first electrode) and an electrode 22 (a second electrode), respectively.

The substrate 10a constitutes an active matrix substrate. Specifically, the substrate 10a includes various signal lines (such as a scanning signal line and a data signal line), a thin film transistor (“TFT”), and an insulating film each of which is provided on a glass substrate 11, and an optical absorption layer 13 and the electrode 12 which are provided on the various signal lines, the thin film transistor, and the insulating film. The optical absorption layer 13 has a characteristic of absorbing light which has entered the optical absorption layer 13 and at least has a wavelength falling within a given range. The optical absorption layer 13 may be colored, and is colored black, for example.

The substrate 20 includes the electrode 22 (a common electrode) which is provided on a glass substrate 21.

The optical modulation layer 30a is provided between the electrodes 12 and 22, and includes a medium 31 and a plurality of shape anisotropic members 32a which are contained in the medium 31. The optical modulation layer 30a receives a voltage applied from a voltage source 33 which is connected with each of the electrodes 12 and 22. In accordance with a change in frequency of the applied voltage, the optical modulation layer 30a changes a reflectance of light (external light) having externally entered the optical modulation layer 30a.

A shape anisotropic member 32a is a responsive member which rotates or deforms in accordance with a direction in which an electric field extends. In terms of a display characteristic, the shape anisotropic member 32a is a member such that an area of a projection image of the shape anisotropic member 32a seen from a direction normal to the substrates 10a and 20 (an area of projection of the shape anisotropic member 32a on the substrates 10a and 20) changes in accordance with a change in frequency of an applied voltage. Further, a projected area ratio (a ratio between a maximum projected area and a minimum projected area) is preferably not less than 2:1.

The shape anisotropic member 32a is a member which has a positive or negative electrostatic property in the medium 31. Specifically, for example, a member which can exchange electrons with, for example, an electrode and a medium, or a member which is modified by an ionic silane coupling agent or the like can be used as the shape anisotropic member 32a.

The shape anisotropic member 32a can have a shape such as a flaky shape, a cylindrical shape, or an elliptic spherical shape. The shape anisotropic member 32a has a characteristic of reflecting visible light. For example, the shape anisotropic member 32a can be made of metal such as aluminum. Further, the shape anisotropic member 32a may be colored. The other characteristics of the shape anisotropic member 32a are identical to those of the shape anisotropic member 32 described in Embodiment 1.

The following description specifically discusses a method in which the optical modulation layer 30a controls a reflectance of light. A case where an aluminum (Al) flake is used as the shape anisotropic member 32a is described here.

In a case where a voltage (alternating current voltage) having a frequency of, for example, 60 Hz is applied as a high frequency voltage to the optical modulation layer 30a, flakes rotate, by a force explained from a dielectrophoresis phenomenon, the Coulomb force, or a viewpoint of electric energy, so that their long axes are parallel to electric lines of force (see (b) of FIG. 6). That is, the flakes are oriented (vertically oriented) so that their long axes are vertical to the substrates 10a and 20. Therefore, external light having entered the optical modulation layer 30a is transmitted (passes) through the optical modulation layer 30a and is then absorbed by the optical absorption layer 13. This allows an observer to observe a black color of the optical absorption layer 13 (allows a black display to be carried out).

Meanwhile, in a case where a voltage having a frequency of, for example, 0.1 Hz or a direct current voltage (having a frequency of 0 Hz) is applied as a low frequency voltage to the optical modulation layer 30a, flakes having an electrostatic property are drawn, by a force explained from an electrophoresis force or the Coulomb force, to a vicinity of the electrode which is charged with an electric charge whose polarity is reverse to that of an electric charge with which the flakes are charged. Then, while being most stably oriented, the flakes rotate so as to adhere to the substrate 10a or the substrate 20. That is, the flakes are oriented (horizontally oriented) so that their long axes are parallel to the substrates 10a and 20 (see (a) of FIG. 6). Therefore, external light having entered the optical modulation layer 30a is reflected by the flakes. This makes it possible to carry out a reflection display.

As described earlier, in a case where a colored layer (optical absorption layer 13) is provided on the back surface side of the display panel 2, a reflected color of the flakes is observed when the flakes are horizontally oriented, and the colored layer is observed when the flakes are vertically oriented. For example, in a case where the colored layer is black and the flakes are made of metallic pieces, reflection from the metallic pieces is obtained when the flakes are horizontally oriented, and a black display is obtained when the flakes are vertically oriented. In a case where the flakes are formed so that the metallic pieces have an average diameter of, for example, not more than 20 μm, the flakes are each formed to have an uneven surface so as to have a light scattering property, or the flakes are each formed have an extremely irregular contour, reflected light is scattered, so that a white display can be obtained.

Note here that (a) of FIG. 6 illustrates a state in which, in a case where a direct current voltage is applied to the optical modulation layer 30a, a polarity (positive) of an electric charge with which the electrode 22 of the substrate 20 is charged and a polarity (negative) of an electric charge with which the flakes are charged differ from each other and the flakes are oriented so as to adhere to the substrate 20. According to the configuration of (a) of FIG. 6 in which configuration the flakes are oriented toward the substrate 20 which is provided on the observer side, in a case where the flakes are contained in a large amount, e.g., in a case where the flakes are contained in an amount exceeding an amount necessary for covering of a surface of the substrate 20 with a single layer of flakes which are horizontally oriented, it is observed from the observer side that an identical plane (reflecting surfaces which are flush with each other) is formed by respective reflecting surfaces of the flakes. This makes it possible to obtain a display which is high in specularity (mirror reflection).

Note also that (a) of FIG. 7 illustrates a state in which, in a case where a direct current voltage is applied to the optical modulation layer 30a, a polarity (positive) of an electric charge with which the electrode 12 of the substrate 10a is charged and a polarity (negative) of an electric charge with which the flakes are charged differ from each other and the flakes are oriented so as to adhere to the substrate 10a. According to the configuration of (a) of FIG. 7 in which configuration the flakes are oriented toward the substrate 10a which is provided on the back surface side, it is observed from the observer side that the flakes are accumulated. This allows an uneven surface to be formed by a plurality of flakes, so that a display in which light is widely scattered can be obtained.

In a case where the horizontal orientation is carried out and the state of (a) of FIG. 6 and the state of (a) of FIG. 7 are switched by controlling a polarity of a direct current voltage to be applied to the optical modulation layer 30a, the display device 1a in which a black display (vertical orientation ((b) of FIG. 6 and (b) of FIG. 7), a white display (horizontal orientation (a) of FIG. 7)), and mirror reflection (horizontal orientation (a) of FIG. 6) are switched can be attained by, for example, providing the black optical absorption layer 13 on the back surface side.

In a case where the substrate 20 is provided with a color filter (not illustrated), parallax occurring between the optical modulation layer 30a and the color filter can be prevented by orienting the flakes toward the substrate 20 as illustrated in (a) of FIG. 6. This makes it possible to carry out a high-quality color display.

As described earlier, according to the display device 1a in accordance with the present embodiment, during a reflection display (horizontal orientation), the shape anisotropic members 32a (here, Al flakes) can be oriented toward the substrate 10a or toward the substrate 20 by switching the polarity of the direct current voltage to be applied to the optical modulation layer 30a.

Further, according to the display device 1a, in a case where the optical absorption layer 13 is a transparent layer or no optical absorption layer 13 is provided, a reflection display can be carried out also on the back surface side (substrate 10a side) because external light having entered the optical modulation layer 30a can be reflected by the shape anisotropic members 32a (see (a) and (b) of FIG. 8). In a case where the shape anisotropic members 32a are vertically oriented, the observer can observe the opposite side of the display panel 2a from the observer. This makes it possible to attain a so-called see-through display panel. The display device 1a thus configured is suitable for, for example, a shop window.

Note that the display device 1a may also be configured such that the optical absorption layer 13 provided on the back surface side of the display panel 2a is replaced with a light reflection layer in which regular reflection or scatter reflection is carried out, the flakes are made of colored members, a colored display is carried out by the flakes during the horizontal orientation, and a reflection display is carried out by the light reflection layer during the vertical orientation.

The display device 1a in accordance with the present embodiment can be provided for, for example, a non-display surface (such as a body surface which is not a normal image display surface) of a mobile phone or the like. In a case where such a mobile phone is configured such that the electrodes 12 and 22 of the display device 1a are made of transparent electrodes, a body color of the mobile phone can be displayed on the non-display surface by vertically orienting the flakes, whereas the flakes which are colored can be displayed on the non-display surface or external light can be reflected by horizontally orienting the flakes. Note that the flakes which are horizontally oriented can also be used as a mirror (mirror reflection). The display device 1a thus configured allows the electrodes 12 and 22 to be made of segment electrodes or flat solid electrodes, so that a simpler circuit configuration can be attained.

Further, the display device 1a in accordance with the present embodiment is also applicable to, for example, a switching panel for a 2D/3D display. Specifically, the display device 1a serving as a switching panel is provided on a front surface of a normal liquid crystal display panel. The display device 1a is configured such that the flakes which are colored black are provided in stripes. According to the configuration, during a 2D display, an image which is displayed over the entire surface of the liquid crystal display panel is made visually recognizable by vertically orienting the flakes. Meanwhile, during a 3D display, stripes are formed by horizontally orienting the flakes, and an image for right and an image for left are displayed in the liquid crystal display panel so that the observer recognizes these images as a three-dimensional image. This makes it possible to attain a liquid crystal display device which is capable of switching between a 2D display and a 3D display. The configuration is also applicable to a liquid crystal display device which carries out a multi-view (e.g., dual-view) display.

### Embodiment 3

A display device in accordance with Embodiment 3 of the present invention is described below with reference to the drawings.

Note that the following description mainly discusses points of difference from the respective display devices in accordance with Embodiments 1 and 2. Note also that members having functions identical to those of the respective members described in Embodiments 1 and 2 are given respective identical reference numerals, and a description of those members is omitted here.

(a) and (b) of FIG. 9 are cross-sectional views each illustrating an overall configuration of a display device 1b in accordance with Embodiment 3. The display device 1b includes a display panel 2b, a backlight 3 which emits light to the display panel 2b, and a driving circuit (not illustrated). The display device 1b is a so-called semi-transmissive display device which carries out a display by transmitting, through the display panel 2b, light emitted from the backlight 3 and carries out the display by reflecting external light having entered the display panel 2b.

The display panel 2b includes a pair of substrates 10 and 20 which are provided so as to face each other, and an optical modulation layer 30b which is provided between the pair of substrates 10 and 20. The substrate 10 (a first substrate) is provided on a back surface side of the display panel 2b, and the substrate 20 (a second substrate) is provided on a display surface side (observer side) of the display panel 2b. Further, the display panel 2b includes many pixels which are provided in a matrix pattern.

The substrates 10 and 20 are provided with respective insulating substrates made of, for example, transparent glass substrates, and an electrode 12 (a first electrode) and an electrode 22 (a second electrode), respectively. The substrates 10 and 20 are identical in configuration to those described in Embodiment 1.

The optical modulation layer 30b is provided between the electrodes 12 and 22, and includes a medium 31 and a plurality of shape anisotropic members 32a which are contained in the medium 31. The optical modulation layer 30b receives a voltage applied from a voltage source 33 which is connected with each of the electrodes 12 and 22. In accordance with a change in frequency of the applied voltage, the optical modulation layer 30b changes a transmittance of light having entered the optical modulation layer 30b from the backlight 3 and a reflectance of light (external light) having externally entered the optical modulation layer 30b.

A shape anisotropic member 32a is identical in configuration to that described in Embodiment 2. That is, the shape anisotropic member 32a is a responsive member which rotates or deforms in accordance with a direction in which an electric field extends. The shape anisotropic member 32a has a positive or negative electrostatic property in the medium, and has a characteristic of reflecting visible light. For example, an aluminum (Al) flake can be used as the shape anisotropic member 32a.

According to the configuration, in a case where a voltage (alternating current voltage) having a frequency of, for example, 60 Hz is applied as a high frequency voltage to the optical modulation layer 30b, flakes rotate, by a force explained from a dielectrophoresis phenomenon, the Coulomb force, or a viewpoint of electric energy, so that their long axes are parallel to electric lines of force (see (b) of FIG. 9). That is, the flakes are oriented (vertically oriented) so that their long axes are vertical to the substrates 10 and 20. This causes light having entered the optical modulation layer 30 to be transmitted (pass) through the optical modulation layer 30 and then exit to the observer side. A transmission display is thus carried out.

Meanwhile, in a case where a voltage having a frequency of, for example, 0.1 Hz or a direct current voltage (having a frequency of 0 Hz) is applied as a low frequency voltage to the optical modulation layer 30a, flakes having an electrostatic property are drawn, by a force explained from an electrophoresis force or the Coulomb force, to a vicinity of the electrode which is charged with an electric charge whose polarity is reverse to that of an electric charge with which the flakes are charged. Then, while being most stably oriented, the flakes rotate so as to adhere to the substrate 10 or the substrate 20. That is, the flakes are oriented (horizontally oriented) so that their long axes are parallel to the substrates 10 and 20 (see (a) of FIG. 9). Therefore, external light having entered the optical modulation layer 30b is reflected by the flakes. This makes it possible to carry out a reflection display.

The semi-transmissive display device 1b in accordance with Embodiment 3 may have not only the configuration described earlier but also the following configuration. The following modification refers the display device 1b as a display device 1c.

The display device 1c carries out a transmission display (transmission mode) by use of light from a backlight in a comparatively dark place, e.g., indoors. Meanwhile, the display device 1c carries out a reflection display (reflection mode) by use of external light in a comparatively bright place, e.g., outdoors. This makes it possible to carry out a display having a high contrast ratio regardless of ambient brightness. That is, the display device 1c, which can be displayed under any illumination (light environment) either indoors or outdoors, is suitable for mobile devices such as a mobile phone, a PDA, and a digital camera.

The display device 1c includes a display panel 2c which includes pixels each of which is provided with a reflection display section for use in the reflection mode and a transmission display section for use in the transmission mode. The display device 1c includes a substrate 10c and a substrate 20c. The substrate 10c is provided with a transparent electrode (pixel electrode) which is made of ITO or the like and included in the transmission display section and a reflecting electrode (pixel electrode) which is made of aluminum or the like and included in the reflection display section. The substrate 20c is provided with a common electrode which is made of ITO or the like and faces the transparent electrode and the reflecting electrode. An optical modulation layer 30c is provided with a shape anisotropic member 32c, which is made of a material having a characteristic of reflecting no visible light.

The display device 1c can be configured to include a sensor which detects ambient brightness, and to switch between a transmission display mode and a reflection display mode in accordance with the detected ambient brightness.

The configuration of the display device 1c makes it possible to turn off a backlight in the reflection display mode. This allows a reduction in electric power consumption.

As described earlier, the display devices 1b and 1c each have the configuration in which a display is carried out by switching between the reflection display mode and the transmission display mode.

### Embodiment 4

A display device in accordance with Embodiment 4 of the present invention is described below with reference to the drawings.

Note that the following description mainly discusses points of difference from the respective display devices in accordance with Embodiments 1 through 3. Note also that members having functions identical to those of the respective members described in Embodiments 1 through 3 are given respective identical reference numerals, and a description of those members is omitted here.

(a) and (b) of FIG. 10 are cross-sectional views each illustrating an overall configuration of a display device 1d in accordance with Embodiment 4. The display device 1d includes a display panel 2d, a backlight 3 which emits light to the display panel 2d, and a driving circuit (not illustrated). The display device 1d is a display device which carries out a color display.

The display panel 2d includes a pair of substrates 10 and 20d which are provided so as to face each other, and an information display optical modulation layer 4 which is provided between the pair of substrates 10 and 20d. The substrate 10 (a first substrate) is provided on a back surface side of the display panel 2d, and the substrate 20d (a second substrate) is provided on a display surface side (observer side) of the display panel 2d. Further, the display panel 2d includes many pixels which are provided in a matrix pattern.

The substrate 20d includes a color filter 23. The color filter 23 includes electrodes 231 which correspond to the respective pixels, an electrode 232 (common electrode), and an optical modulation layer 233 which is provided between the electrodes 231 and the electrode 232. Note that the electrodes 231 may be provided all over the pixels so as to be shared by all the pixels. The optical modulation layer 233 includes a medium 234, a plurality of shape anisotropic members 235 which are contained in the medium 234, and ribs 236 for obtaining, by partitioning, regions which correspond to the respective pixels.

It is possible to use, as the shape anisotropic members 235, flakes obtained by causing transparent resin to contain a coloring matter (or dye) or a pigment, e.g., red (R) flakes, green (G) flakes, and blue (B) flakes. These flakes are provided by color in the regions obtained by partitioning by the ribs 236, which are provided in stripes.

The flakes and the medium can be produced by, for example, applying a mixture of the flakes and the medium separately by an ink-jet process. Note that the respective regions of the colors are obtained by partitioning by the ribs 236 so as to correspond to the respective pixels. The information display optical modulation layer 4 may be identical in configuration to the optical modulation layers described in Embodiments 1 through 3. Alternatively, generally, the information display optical modulation layer 4 may be a liquid crystal layer.

According to the configuration, a color display is carried out by horizontally orienting the flakes so as to cause light entering the color filter 23 to be transmitted through the flakes of each of the colors. Meanwhile, a black and white display is carried out by vertically orienting the flakes so as to cause light entering the color filter 23 to directly reach an observer. By carrying out a color display and a black and white display as described above, in a case where a transmissive display, for example is carried out, a color display can be carried out, and in a case where black and white content such as an electronic book is displayed, an optical loss caused by a color filter can be prevented, so that a backlight can consume lower electric power. In addition, in a case where a reflective display is carried out, a color display can be carried out, and a display in which great importance is placed on lightness can be carried out by carrying out a black and white display in an environment which is dark and less visually recognizable.

The configuration thus makes it possible to attain a display device which is capable of switching between a color display and a black and white display.

Note that a configuration of the color filter 23 is not limited to the configuration described earlier. Alternatively, the color filter 23 may include at least a part of a red-colored shape anisotropic member, a green-colored shape anisotropic member, a blue-colored shape anisotropic member, a cyan (C)-colored shape anisotropic member, a magenta (M)-colored shape anisotropic member, and a yellow (Y)-colored shape anisotropic member. Further, in addition to this, the color filter 23 may be further provided with a region in which no shape anisotropic member is provided. That is, in view of a color reproduction range of a display image, it is preferable that the plurality of shape anisotropic members be made of transparent resin and be configured to include at least the red-colored shape anisotropic member, the green-colored shape anisotropic member, and the blue-colored shape anisotropic member.

The display device in accordance with each of the Embodiments can have not only the configuration described earlier but also the following configuration.

(Cell Thickness)

It is preferable that the optical modulation layer have a thickness (cell thickness) which is large enough for the flakes to be vertically oriented (see, for example, (b) of FIG. 1). However, a thickness of the optical modulation layer is not limited to this. The optical modulation layer may also have a thickness which is large enough to cause the flakes to remain at an intermediate angle (remain obliquely oriented). That is, a cell thickness of the optical modulation layer may be set to a value which is smaller than a length of a long axis of each of the flakes and which prevents light reflected by the flakes from directly exiting to the display surface side when the flakes are obliquely oriented at a maximum angle to the substrates. Specifically, according to, for example, the reflective display device 1a in accordance with Embodiment 2 in which reflective display device the black optical absorption layer 13 is provided on the back surface side of the display panel 2a, in a case where the medium 31 which has a refractive index of 1.5 is used for the optical modulation layer 30a, the cell thickness is set so that an angle θ made between a direction normal to a display panel surface and a direction normal to a flake surface is not less than 42° (see (b) of FIG. 11). This prevents light reflected by the flakes from at least directly exiting through the substrate on the observer side, so that a black display can be suitably carried out.

(Shape 1 of Shape Anisotropic Member)

A configuration of the shape anisotropic members (e.g., flakes) is not limited to a configuration in which the shape anisotropic members freely rotate in the medium of the optical modulation layer. A part of the shape anisotropic members may be fixed to the substrate 10 or the substrate 20. (a) and (b) of FIG. 12 each illustrate a configuration in which flake ends are fixed to the substrate 10.

The following description discusses, with reference to FIG. 13, an example of a method for producing a display panel in which a part of the flakes are fixed to the substrate.

First, a resist layer patterned by a general photolithographic process is formed on the substrate 10 in accordance with a size of the flakes. Next, an aluminum layer, for example is formed by vapor deposition or the like, and a resist layer larger than the above resist layer by a part in which aluminum is fixed to the substrate is pattern-formed. Subsequently, aluminum in shaded areas in (a) of FIG. 13 is removed from such a composite layer by use of an etchant containing, for example, phosphoric acid, nitric acid, and acetic acid. Further, in a case where a resist is removed by use of NMP (N-methyl-pyrrolidone), it is possible to obtain an aluminum molded product a part of which is fixed to the substrate. In a case where the substrate 10 and the substrate 20 which faces the substrate 10 are combined together with a distance which corresponds to, for example, d in (b) of FIG. 13 and is secured between the substrate 10 and the substrate 20 via the medium by use of, for example a spacer or the like, it is possible to produce the display panel 2 (see (a) of FIG. 12) in which a part of the flakes are fixed to the substrate.

According to the display panel 2, in a case where a high frequency voltage is applied to the optical modulation layer 30, the flakes are deformed as illustrated in (b) of FIG. 12, so that a light transmission state can be obtained. Meanwhile, in a case where a voltage such as a direct current voltage which causes the flakes (assume here that an electric charge with which the flakes are charged has a negative polarity) to adhere to the substrate 10 is applied, the flakes are restored to have an original shape as illustrated in (a) of FIG. 12, so that a light blocking state can be obtained.

Note that as an example of another configuration, the shape anisotropic members (e.g., flakes) may be configured such that a flake whose end is fixed by use of a string, a wire, or the like axially rotates centering on a fixed end.

(Shape 2 of Shape Anisotropic Member)

It is also possible to use, as a shape anisotropic member, a flake which is bowl-shaped (has an uneven surface). (a) and (b) of FIG. 14 each illustrate a state in which bowl-shaped flakes are used in the reflective display device 1a in accordance with Embodiment 2.

The bowl-shaped flakes allow a further increase in light scattering property than the flat (plane) flakes (see FIG. 5). Note that (c) of FIG. 14 illustrates a state in which a direct current voltage whose polarity is reverse to that of a direct current voltage which is applied to the optical modulation layer 30a in (a) of FIG. 14 is applied to the optical modulation layer 30a.

(Shape 3 of Shape Anisotropic Member)

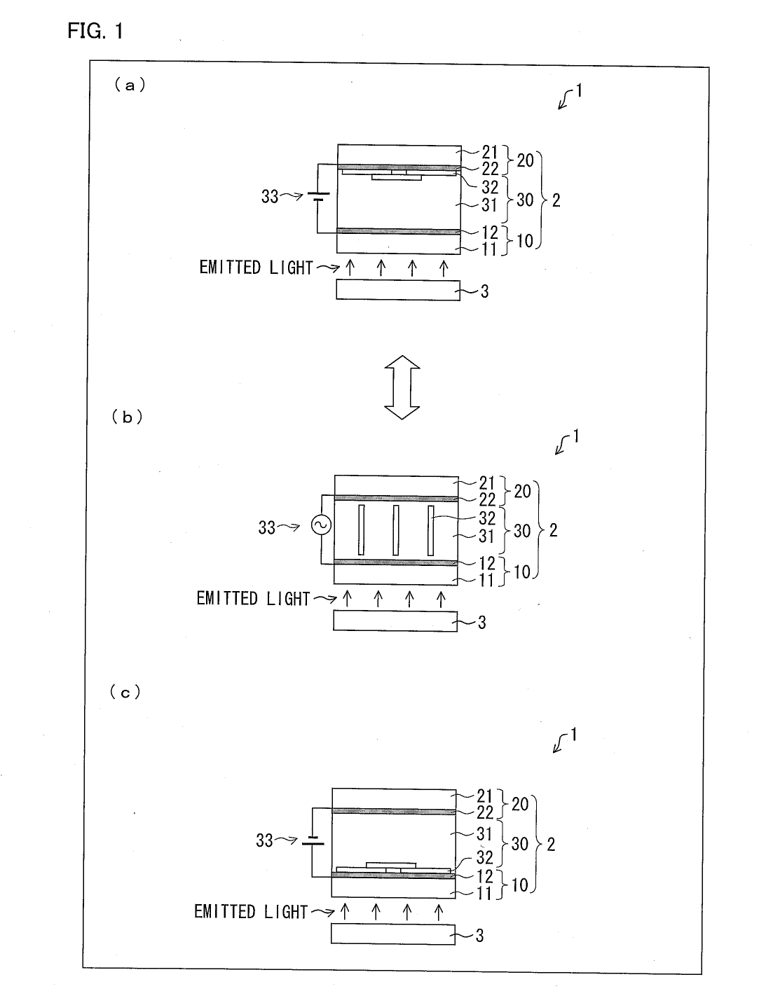

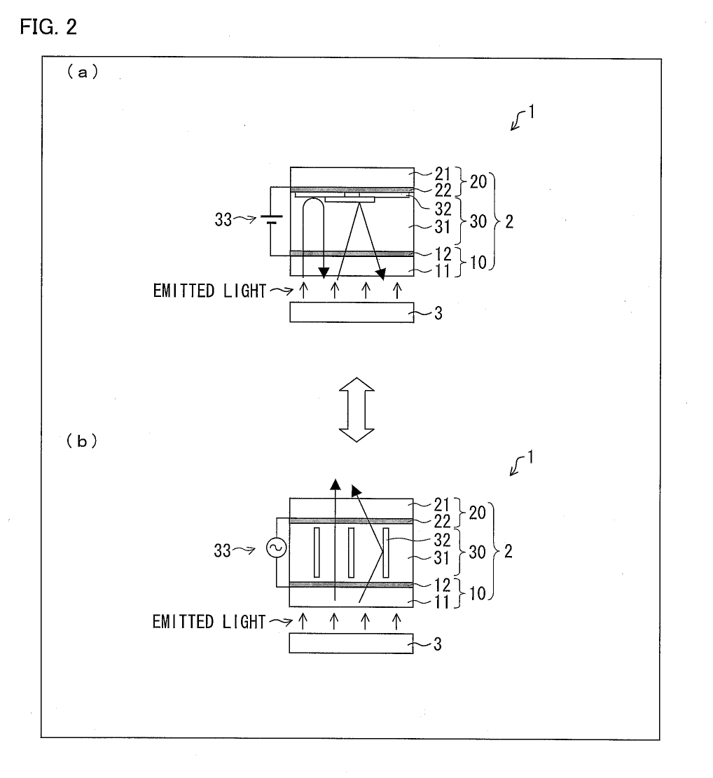

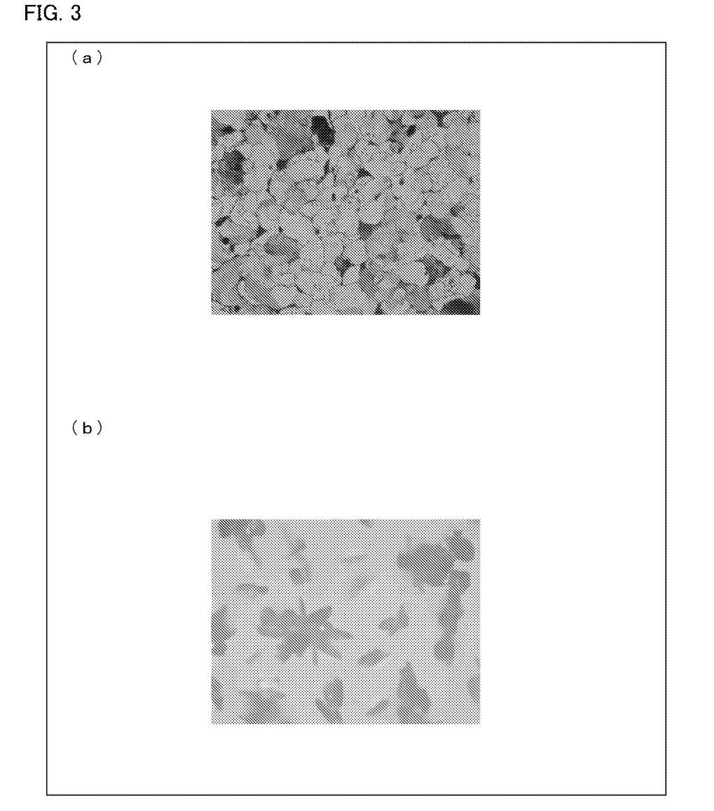

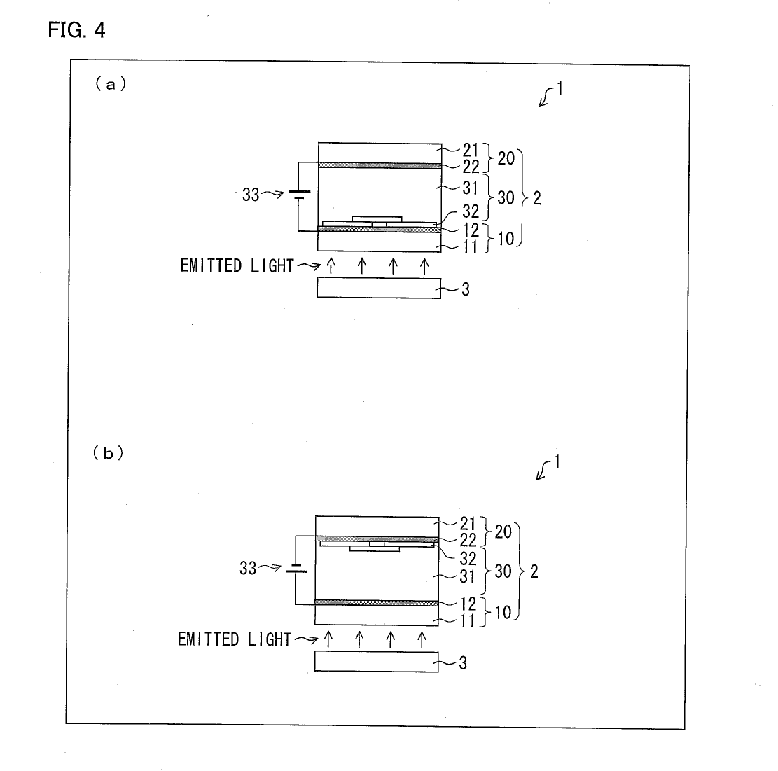

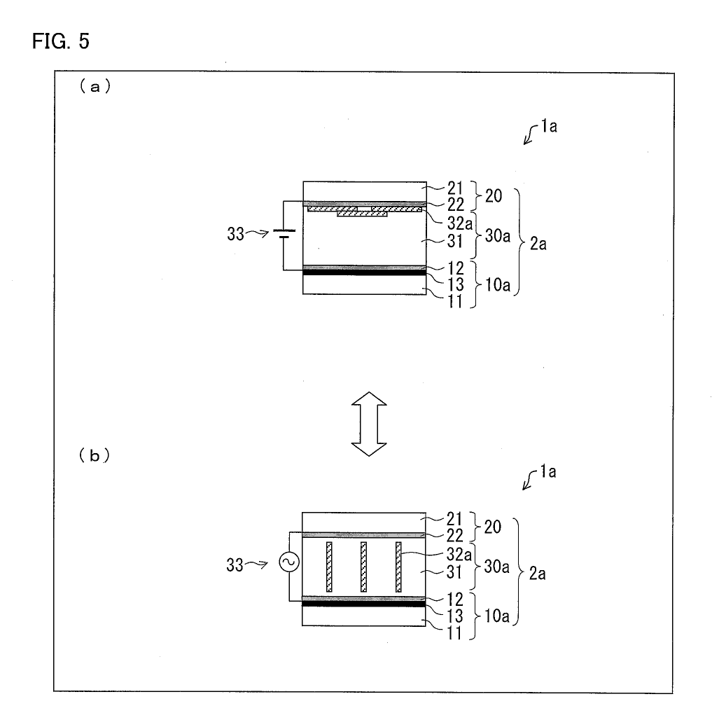

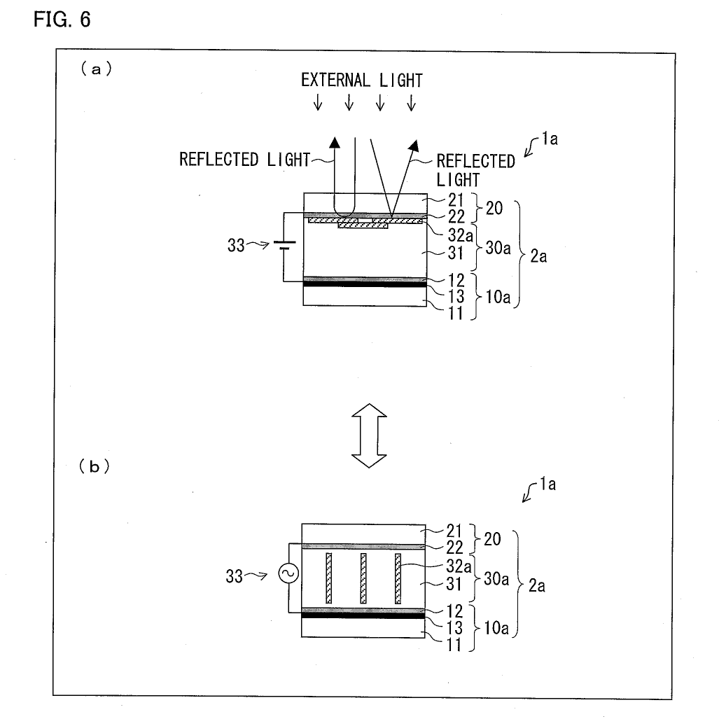

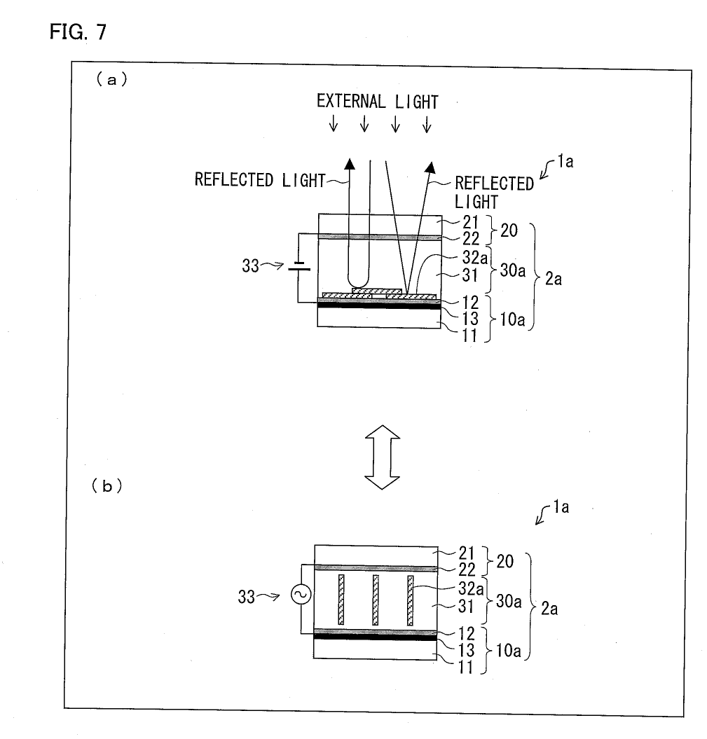

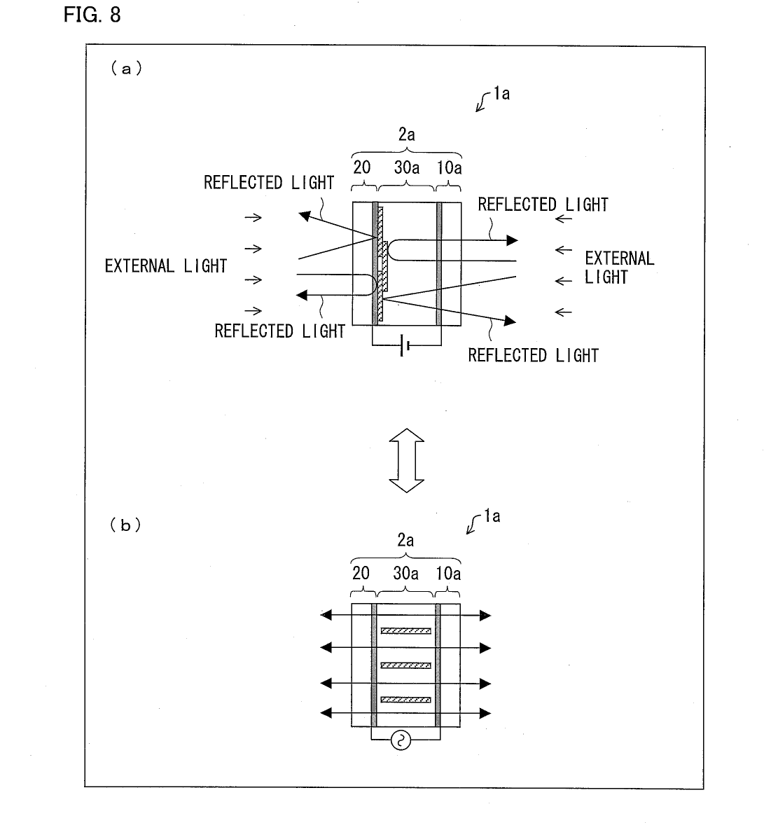

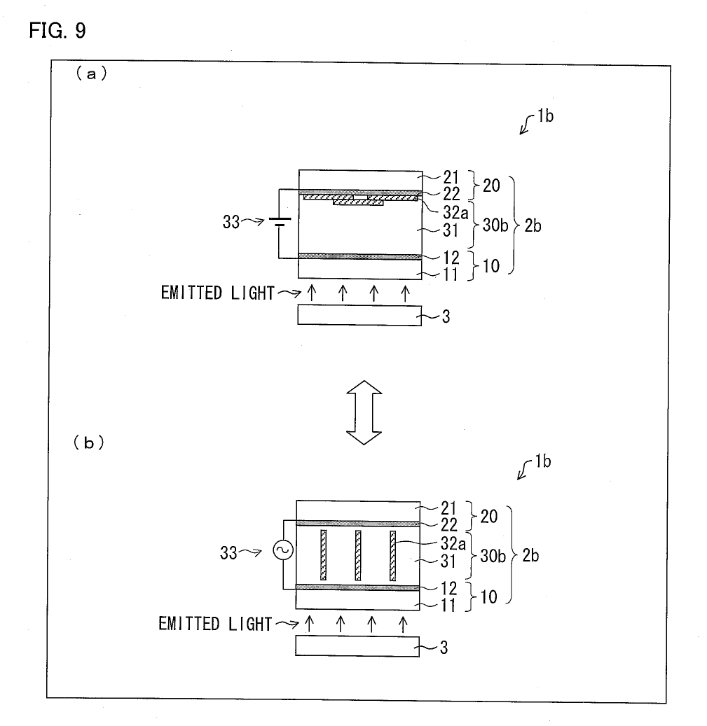

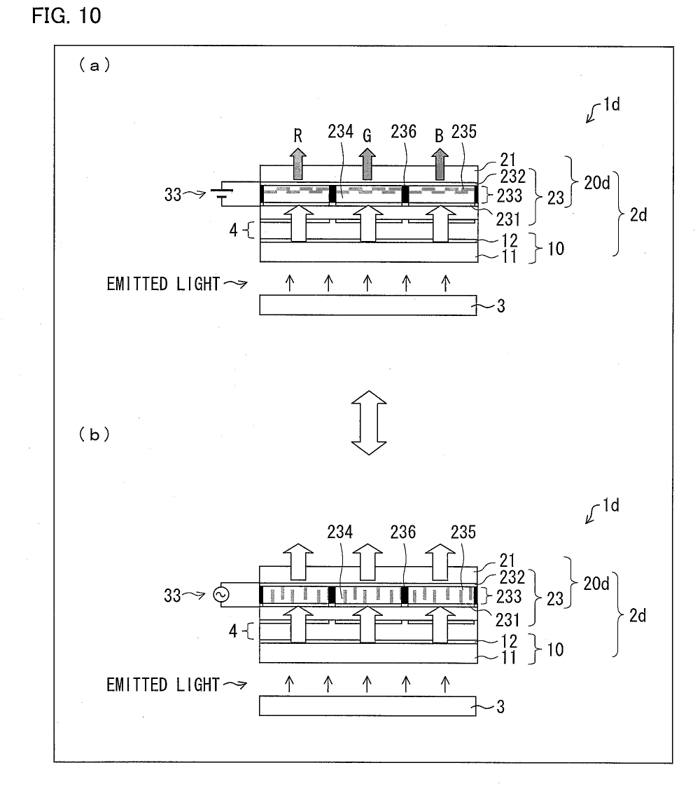

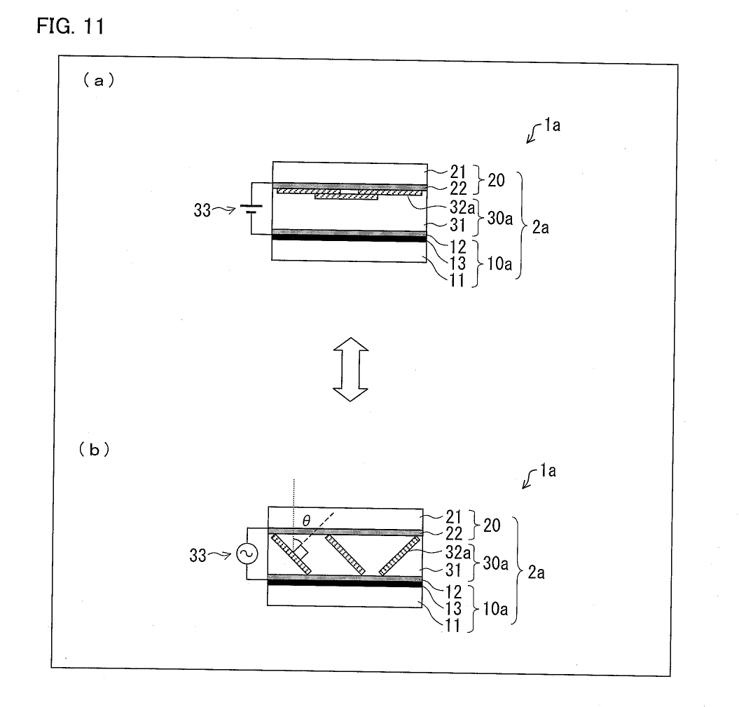

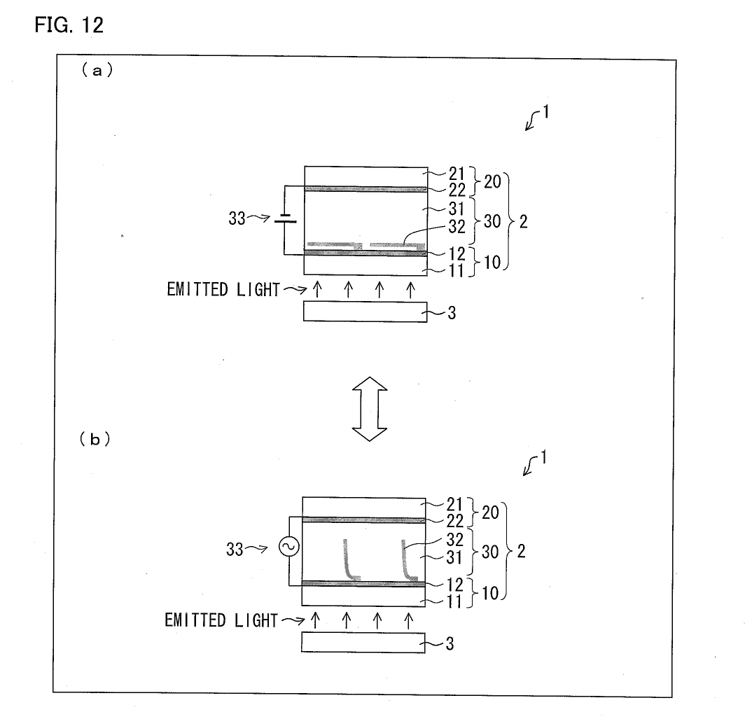

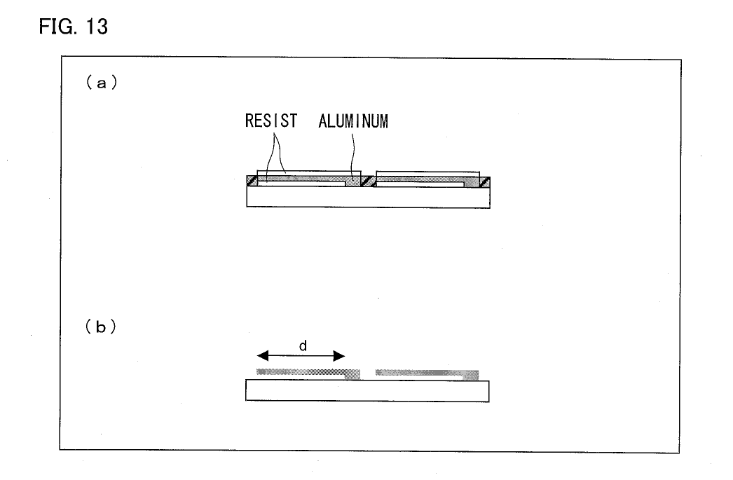

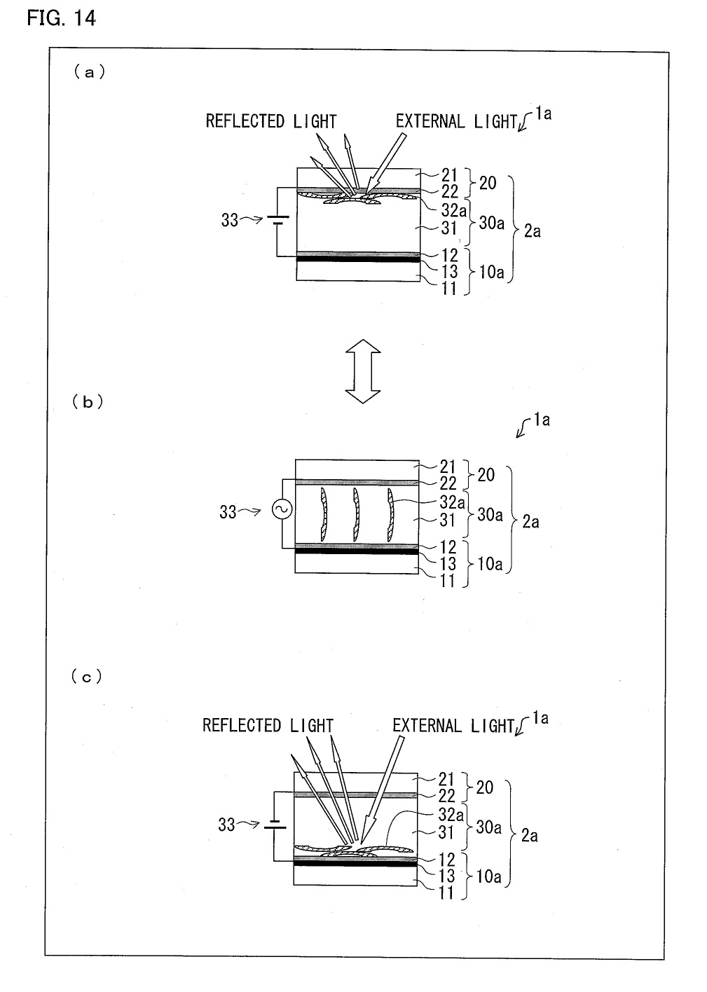

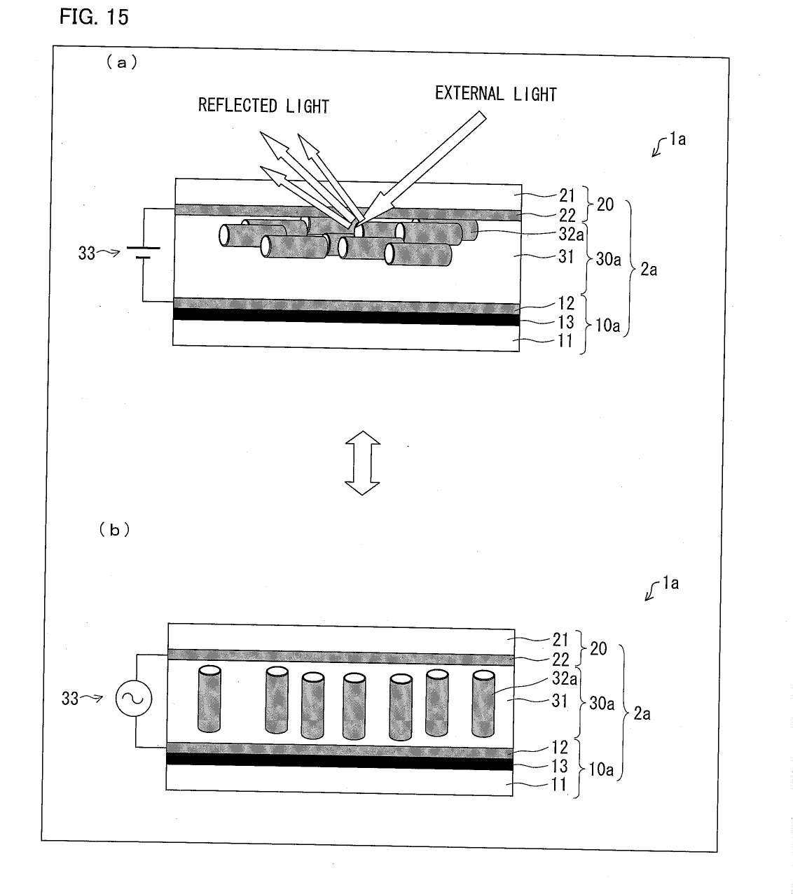

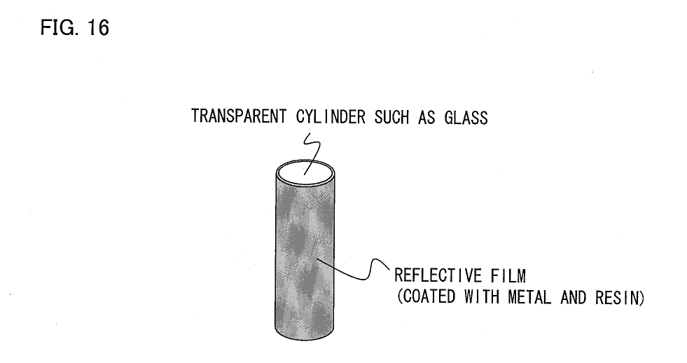

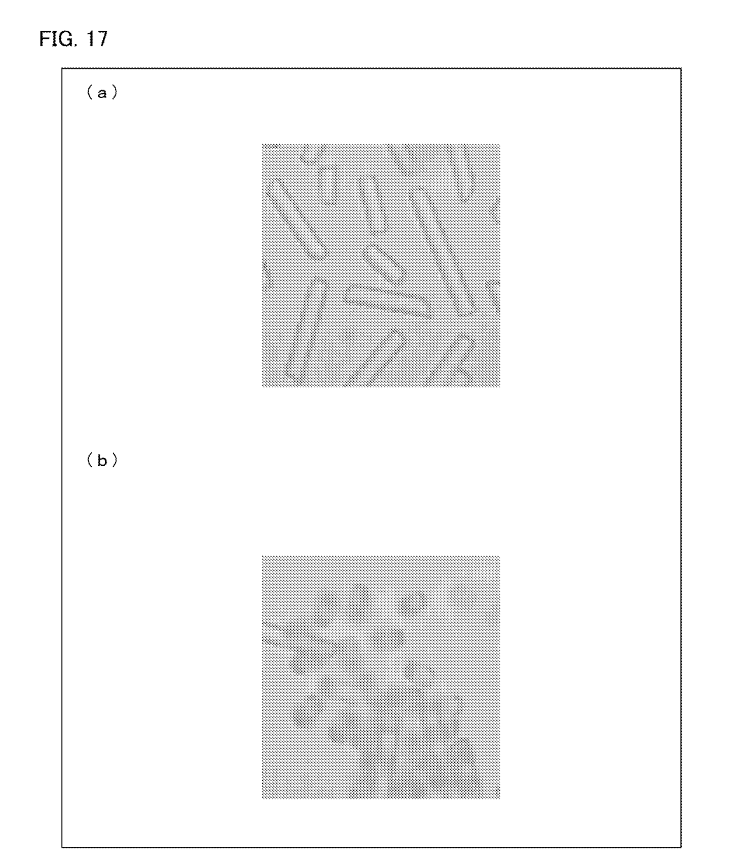

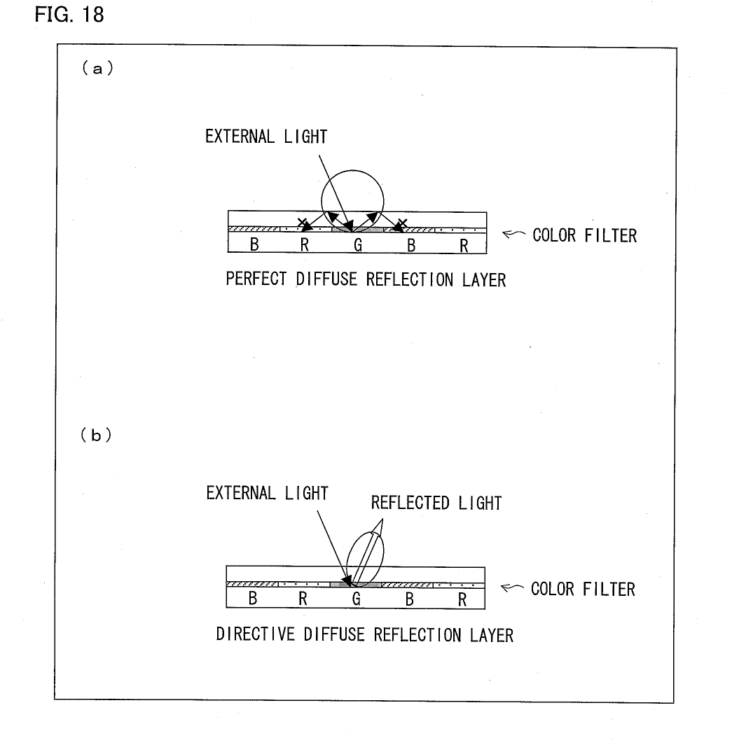

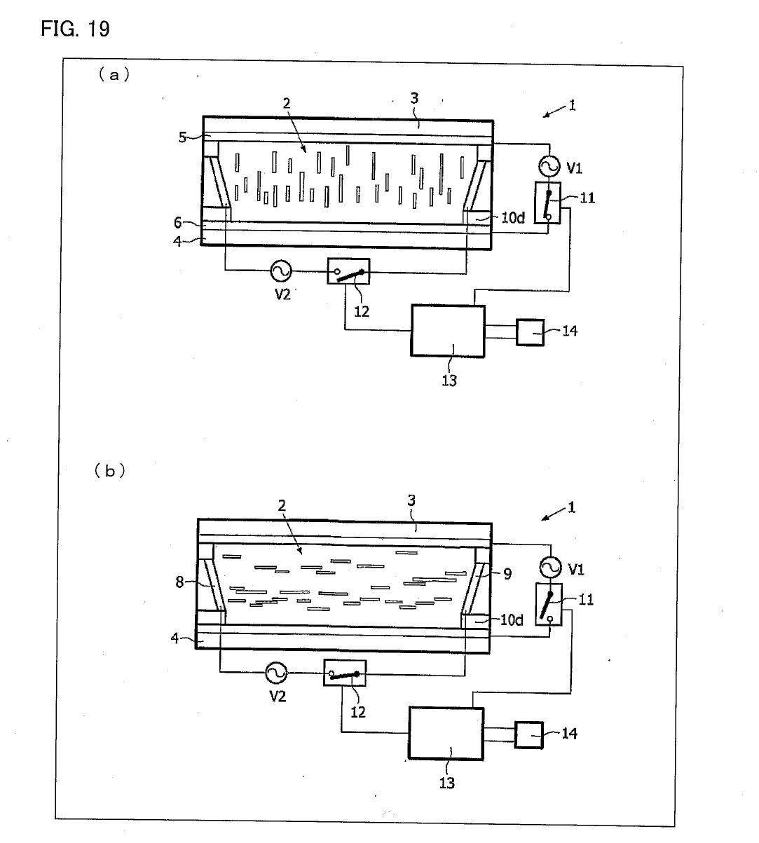

The shape anisotropic members may be formed to be fiber-like. (a) and (b) of FIG. 15 each illustrate a state in which fiber-like shape anisotropic members are used in the reflective display device 1a in accordance with Embodiment 2. For example, a fiber-like shape anisotropic member (referred to as a fiber) can have a configuration obtained by coating transparent cylindrical glass with a reflective film (metal or metal and resin) (see FIG. 16). (a) of FIG. 15 illustrates a state in which a reflection display (white display) is carried out by horizontally orienting fibers by applying, to the optical modulation layer 30a, a voltage having a frequency of, for example, 0.1 Hz or a direct current voltage as a low frequency voltage. In a case where the horizontal orientation is carried out, external light is scatter-reflected by the reflective film of the fiber, so that a white display is carried out. (b) of FIG. 15 illustrates a state in which a transmission display (black display) is carried out by vertically orienting fibers by applying a voltage having a frequency of, for example, 60 Hz (an alternating current voltage) as a high frequency voltage. In a case where the vertical orientation is carried out, after being reflected by the fibers, external light travels toward the substrate 10 and is then absorbed by the optical absorption layer 13, so that a black display is carried out.

(a) of FIG. 17 is an image obtained by photographing how the fibers are horizontally oriented (in plan view), and (b) of FIG. 3 is an image obtained by photographing how the fibers are vertically oriented (in plan view). Here, photographing is carried out by using propylene carbonate for the medium 31, using, as the shape anisotropic members 32, glass fibers having a diameter of 5 μm, setting the cell thickness to 79 μm, setting an applied voltage to 5.0 V (alternating current), and switching a frequency of the applied voltage between 0 Hz (direct current) and 60 Hz. It is revealed that the glass fibers are horizontally oriented in a case where the frequency is set to 0 Hz (direct current) (see (a) of FIG. 17) and that the glass fibers are vertically oriented in a case where the frequency is set to 60 Hz (high frequency) (see (b) of FIG. 17).

(Voltage Application Method)

A voltage application to the optical modulation layer is carried out not only by switching between a direct current voltage and an alternating current voltage but also by substantially switching between a direct current voltage and an alternating current voltage (adjusting a magnitude relationship between a direct current component and an alternating current component) by applying an offset voltage, preferably an offset voltage lower than a maximum alternating current applied voltage to a counter electrode (common electrode) so as to change an intensity (amplitude) of an alternating current applied voltage.

According to the display device of the present invention, it is considered that a halftone display can be carried out by, for example, an intensity and a frequency of an alternating current voltage to be applied to the optical modulation layer, and a size of the flakes. For example, in a case where flakes which differ in size are mixed together, it is possible to change respective rotation angles of the flakes in accordance with respective sizes of the flakes. This is considered to make it possible to control a light transmittance (halftone display) in accordance with an intensity and a frequency of an alternating current voltage.

(Diffuse Reflection Layer)

According to the reflective display device 1a in accordance with Embodiment 2, it is possible to control a scattering property of reflected light by (i) a size, (ii) a shape, (iii) selection of planarity, and iv) a density of the flakes. For example, according to a fine particle electrophoresis display which carries out a white display by scattering titanium oxide or the like, the scattering is approximately isotropic. In a case where a color display is carried out by using a color filter for displaying such a scattering property, light which is scattered by a given color pixel and guided is absorbed by a color filter of another color pixel (see (a) of FIG. 18), so that a great amount of reflected light is lost. In contrast, according to the display device 1a of the present invention, it is possible to provide a scattering state with given directivity (see (b) of FIG. 18), so that a color display with high display quality can be carried out by use of a color filter.

A display panel of the present invention includes: a first substrate and a second substrate which are provided so as to face each other, the first substrate being provided on a back surface side of the display panel, and the second substrate being provided on a display surface side of the display panel; and an optical modulation layer which is provided between the first substrate and the second substrate, which contains a plurality of shape anisotropic members, and which controls a transmittance of light having entered the display panel, the display panel changing an area of projection of the plurality of shape anisotropic members to the first substrate and the second substrate by changing a frequency of a voltage to be applied to the optical modulation layer.

According to the configuration, a transmittance of light can be changed by changing the frequency of the voltage to be applied to the optical modulation layer. Further, the configuration, in which a polarizing plate is omissible, allows a further increase in light use efficiency than a liquid crystal display panel. This makes it possible to attain a display panel which has high light use efficiency while having a simple configuration.

The display panel can be configured such that the display panel switches, between a direct current voltage having a frequency of 0 Hz and an alternating current voltage, the voltage to be applied to the optical modulation layer.

The display panel can be configured such that the alternating current voltage is applied to the optical modulation layer.

The display panel can be configured such that the display panel switches, between a low frequency of not more than a first threshold value and a high frequency of not less than a second threshold value, the frequency of the voltage to be applied to the optical modulation layer, the low frequency and the high frequency each having been set in advance.

The display panel can be configured such that the optical modulation layer blocks light when the direct current voltage or a low frequency voltage is applied to the optical modulation layer, and the optical modulation layer transmits light when a high frequency voltage is applied to the optical modulation layer.

The display panel can be configured such that, when the direct current voltage or the low frequency voltage is applied to the optical modulation layer, the plurality of shape anisotropic members are oriented so that their long axes are parallel to the first substrate and the second substrate, and when the high frequency voltage is applied to the optical modulation layer, the plurality of shape anisotropic members are oriented so that their long axes are vertical to the first substrate and the second substrate.

The display panel is preferably configured such that the plurality of shape anisotropic members have an electrostatic property.

According to this, the plurality of shape anisotropic members can be rotated by changing the frequency of the voltage to be applied to the optical modulation layer. The display panel can be configured such that: the first substrate is provided with a first electrode, and the second substrate is provided with a second electrode; and in a case where the direct current voltage is applied to each of the first substrate and the second substrate, a polarity of an electric charge with which the first substrate is charged and a polarity of an electric charge with which the plurality of shape anisotropic members are charged differ from each other.

According to the configuration, the plurality of shape anisotropic members can be horizontally oriented so as to adhere to the first substrate.

The display panel can be configured such that: the first substrate is provided with a first electrode, and the second substrate is provided with a second electrode; and in a case where the direct current voltage is applied to each of the first substrate and the second substrate, a polarity of an electric charge with which the second substrate is charged and a polarity of an electric charge with which the plurality of shape anisotropic members are charged differ from each other.

According to the configuration, the plurality of shape anisotropic members can be horizontally oriented so as to adhere to the second substrate.

The display panel can be configured such that the display panel changes the area of the projection by rotating the plurality of shape anisotropic members in accordance with the frequency of the voltage to be applied to the optical modulation layer.

The display panel can be configured such that the display panel changes the area of the projection by changing a shape of each of the plurality of shape anisotropic members in accordance with the frequency of the voltage to be applied to the optical modulation layer.

According to the configuration, a part of the plurality of shape anisotropic members can be fixed to the first substrate or the second substrate.

The display panel can be configured such that a part of the plurality of shape anisotropic members are fixed to the first substrate or the second substrate.

The display panel is preferably configured such that the plurality of shape anisotropic members are made of metal, a semiconductor, a dielectric substance, a dielectric multilayer film, or cholesteric resin.

The display panel can be configured such that the plurality of shape anisotropic members are made of metal and reflect emitted light.

This makes it possible to carry out a reflection display.

The display panel may be configured such that the plurality of shape anisotropic members are colored.

The display panel may be configured such that: the optical modulation layer functions as a color filter; and the plurality of shape anisotropic members are made of transparent resin and include at least a red-colored shape anisotropic member, a green-colored shape anisotropic member, and a blue-colored shape anisotropic member.

This makes it possible to carry out a color display.

The display panel is preferably configured such that the plurality of shape anisotropic members are each formed to have a flaky shape, a cylindrical shape, or an elliptic spherical shape.

The display panel can be configured such that the plurality of shape anisotropic members are each formed to have a flaky shape and an uneven surface.

The display panel can be configured such that a thickness of the optical modulation layer is set to a value which is smaller than a length of a long axis of each of the plurality of shape anisotropic members and which prevents light reflected by the plurality of shape anisotropic members from directly exiting to the display surface side when the plurality of shape anisotropic members are obliquely oriented at a maximum angle to the first substrate and the second substrate.

This allows the optical modulation layer to have a smaller thickness, so that a thinner display panel can be attained.

The display panel may be configured such that the first substrate is provided with a colored layer.

In order to attain the object, a display device includes the display panel mentioned above and a backlight which is provided so as to face the first substrate.

According to the configuration, a transmittance of light can be changed by changing the frequency of the voltage to be applied to the optical modulation layer. Further, the configuration, in which a polarizing plate is omissible, allows a further increase in light use efficiency than a liquid crystal display panel. This makes it possible to attain a display panel which has high light use efficiency while having a simple configuration.

The display device can be configured such that: the display device has a reflection display mode in which the display device carries out a display by reflecting light having entered the display device from external light and a transmission display mode in which the display device carries out the display by transmitting light emitted from the backlight; and the display device carries out the display by switching between the reflection display mode and the transmission display mode.

This makes it possible to attain a so-called semi-transmissive display device.

The display device can be configured such that: the display device carries out the display in the reflection display mode by causing the plurality of shape anisotropic members to reflect external light having entered the display device; and the display device carries out the display in the transmission display mode by causing light from the backlight to pass through the optical modulation layer.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitable for a display of, for example, a television.

### REFERENCE SIGNS LIST

1, 1a, 1b, 1c, 1d Display device
2, 2a, 2b, 2c, 2d Display panel
3 Backlight
4 Information display optical modulation layer
10, 10a Substrate (first substrate)
11 Glass substrate
12 Electrode (first electrode, pixel electrode)
13 Optical absorption layer
20 Substrate (second substrate)
21 Glass substrate
22 Electrode (second electrode, common electrode)
23 Color filter
30, 30a, 30b, 30c, 30d Optical modulation layer
31 Medium
32, 32a Shape anisotropic member
33 Voltage source

1-22. (canceled)

23. A display panel comprising:
a first substrate and a second substrate which are provided so as to face each other, the first substrate being provided on a back surface side of the display panel, and the second substrate being provided on a display surface side of the display panel; and
an optical modulation layer which is provided between the first substrate and the second substrate, which contains a plurality of shape anisotropic members, and which controls a transmittance of light having entered the display panel,
the display panel changing an area of projection of the plurality of shape anisotropic members to the first substrate and the second substrate by changing a frequency of a voltage to be applied to the optical modulation layer, and
the display panel switching, between a direct current voltage and an alternating current voltage, the voltage to be applied to the optical modulation layer.

24. The display panel as set forth in claim 23, wherein the optical modulation layer blocks light when the direct current voltage is applied to the optical modulation layer, and the optical modulation layer transmits light when the alternating current voltage is applied to the optical modulation layer.

25. The display panel as set forth in claim 24, wherein, when the direct current voltage is applied to the optical modulation layer, the plurality of shape anisotropic members are oriented so that their long axes are parallel to the first substrate and the second substrate, and when the alternating current voltage is applied to the optical modulation layer, the plurality of shape anisotropic members are oriented so that their long axes are vertical to the first substrate and the second substrate.

26. The display panel as set forth in claim 23, wherein:
the plurality of shape anisotropic members have an electrostatic property;
the first substrate is provided with a first electrode, and the second substrate is provided with a second electrode; and
in a case where the direct current voltage is applied to each of the first substrate and the second substrate, a polarity of an electric charge with which the first substrate is charged and a polarity of an electric charge with which the plurality of shape anisotropic members are charged differ from each other.

27. The display panel as set forth in claim 23, wherein:
the plurality of shape anisotropic members have an electrostatic property;
the first substrate is provided with a first electrode, and the second substrate is provided with a second electrode; and
in a case where the direct current voltage is applied to each of the first substrate and the second substrate, a polarity of an electric charge with which the second substrate is charged and a polarity of an electric charge with which the plurality of shape anisotropic members are charged differ from each other.

28. The display panel as set forth in claim 23, wherein the display panel changes the area of the projection by rotating the plurality of shape anisotropic members in accordance with the frequency of the voltage to be applied to the optical modulation layer.

29. The display panel as set forth in claim 23, wherein the display panel changes the area of the projection by changing a shape of each of the plurality of shape anisotropic members in accordance with the frequency of the voltage to be applied to the optical modulation layer.

30. The display panel as set forth in claim 28, wherein a part of the plurality of shape anisotropic members are fixed to the first substrate or the second substrate.

31. The display panel as set forth in claim 29, wherein a part of the plurality of shape anisotropic members are fixed to the first substrate or the second substrate.

32. The display panel as set forth in claim 23, wherein the plurality of shape anisotropic members are made of metal, a semiconductor, a dielectric substance, a dielectric multilayer film, or cholesteric resin.

33. The display panel as set forth in claim 23, wherein the plurality of shape anisotropic members are made of metal and reflect emitted light.

34. The display panel as set forth in claim 23, wherein the plurality of shape anisotropic members are colored.

35. The display panel as set forth in claim 23, wherein:
the optical modulation layer functions as a color filter; and
the plurality of shape anisotropic members are made of transparent resin and include at least a red-colored shape anisotropic member, a green-colored shape anisotropic member, and a blue-colored shape anisotropic member.

36. The display panel as set forth in claim 23, wherein the plurality of shape anisotropic members are each formed to have a flaky shape, a cylindrical shape, or an elliptic spherical shape.

37. The display panel as set forth in claim 23, wherein the plurality of shape anisotropic members are each formed to have a flaky shape and an uneven surface.

38. The display panel as set forth in claim 33, wherein a thickness of the optical modulation layer is set to a value which is smaller than a length of a long axis of each of the plurality of shape anisotropic members and which prevents light reflected by the plurality of shape anisotropic members from directly exiting to the display surface side when the plurality of shape anisotropic members are obliquely oriented at a maximum angle to the first substrate and the second substrate.

39. The display panel as set forth in claim 33, wherein the first substrate is provided with a colored layer.

40. A display device comprising the display panel recited in claim 23 and a backlight which is provided so as to face the first substrate.

41. The display device as set forth in claim 40, wherein:
the display device has a reflection display mode in which the display device carries out a display by reflecting light having externally entered the display device and a transmission display mode in which the display device carries out the display by transmitting light emitted from the backlight; and
the display device carries out the display by switching between the reflection display mode and the transmission display mode.

42. The display device as set forth in claim 41, wherein:
the display device carries out the display in the reflection display mode by causing the plurality of shape anisotropic members to reflect external light having entered the display device; and
the display device carries out the display in the transmission display mode by causing light from the backlight to pass through the optical modulation layer.
